(19) United States
(12) Patent Application Publication
(10) Pub. No.: US 2013/0102723 A1
(43) Pub. Date: Apr. 25, 2013

(54) THERMOPLASTIC POLYURETHANES AND USE THEREOF

(71) Applicant: Bayer Intellectual Property GmbH, Monheim (DE)

(72) Inventors: Christian Wamprecht, Neuss (DE); Faisal Shafiq, Krefeld-Fischein (DE)

(73) Assignee: Bayer Intellectual Property GmbH, Monheim (DE)

(21) Appl. No.: 13/660,482

(22) Filed: Oct. 25, 2012

(30) Foreign Application Priority Data
Oct. 25, 2011 (DE) 10 2011 085 182.8

(51) Int. Cl. C08G 18/32; C09D 175/04; C08L 83/04; C08G 18/44; C08L 75/04

(52) U.S. Cl. CPC C08G 18/3203; C08G 18/44; C08L 75/04; C08L 83/04; C09D 175/04
USPC 524/537; 528/85; 525/453

(57) ABSTRACT

The present invention relates to thermoplastic polyurethane moulding compositions with improved surface resistance (write resistance and scratch resistance) and very good technical processibility and also to the use thereof.

### CROSS REFERENCE TO RELATED APPLICATIONS

Priority is claimed to German Patent Application No. 102011085182.8, filed Oct. 25, 2011 which is incorporated herein by reference, in its entirety, for all useful purposes.

### BACKGROUND

The present invention relates to thermoplastic polyurethane moulding compositions with very high surface resistance (write resistance, scratch resistance and abrasion resistance), very good weathering resistance, UV resistance and hydrolysis resistance, very little blooming behaviour, very good technical processibility with a large processing window, and also to the use thereof, in particular for producing large-area injection mouldings for external applications.

On account of their good elastomer properties and thermoplastic processibility, thermoplastic polyurethanes (TPU) are of great technical significance. An overview of the production, properties and applications of TPU is given, for example, in the Kunststoff Handbuch [G. Becker, D. Braun], Volume 7, Polyurethane, Munich, Vienna, Carl Hanser Verlag, 1983.

TPU are mostly synthesised from linear polyols (macrodiols) such as polyester diols, polyether diols or polycarbonate diols, organic diisocyanates and short-chain, mostly difunctional alcohols (chain extenders). They can be produced continuously or discontinuously. The most well-known production processes are the belt process (GB-A 1 057 018) and the extruder process (DE-A 19 64 834).

Synthesis of the thermoplastically processible polyurethane elastomers may be undertaken either stepwise (prepolymer process) or by the simultaneous reaction of all the components in one stage (one-shot process).

In DE-A 102 30 020 the use of polyorganosiloxanes for improving the rub resistance and scratch resistance (mechanical surface resistance) for TPU is described. In the course of the processing of the TPU that contain these additives, however, surface defects appear after some time (after a few shots) in the injection-moulding process, which result in undesirable increased reject-rates.

In EP-A 2 083 026 the use of special mixtures of low-molecular and high-molecular polyorganosiloxanes for improving the rub resistance and scratch resistance (mechanical surface resistance) for TPU is described. In the course of the processing of the TPU that contains these additive mixtures, however, at low processing temperatures (<180° C.) surface defects and delamination occasionally appear in the injection-moulding process, which result in undesirable increased reject-rates.

The object of the present invention was therefore to make thermoplastic polyurethanes (TPU) available that have a very good mechanical surface resistance and at the same time possess a particularly high weathering resistance, UV resistance and hydrolysis resistance and also exhibit outstanding technical processibility, in particular a broad processing window with respect to the processing temperature, and also no surface defects, in particular delamination, in the course of processing.

This object was able to be achieved by means of compositions on the basis of special TPU containing a special additive mixture.

### BRIEF DESCRIPTION OF EMBODIMENTS

The present invention therefore provides compositions containing thermoplastic polyurethanes that are obtainable from

a) an isocyanate component, substantially consisting of
a1) 50 to 100 mol % 1,6-hexamethylene diisocyanate and
a2) 0 to 50 mol % of an aliphatic diisocyanate that is different from 1,6-hexamethylene diisocyanate, or a mixture of such aliphatic diisocyanates and/or cycloaliphatic diisocyanates.

b) a low-molecular polyol component, substantially consisting of
b1) 30 to 100 mol % of at least one difunctional chain extender with a number-average molecular weight M̅ₙ from 76 to 286 g/mol and
b2) 0 to 70 mol % of one or more chain extenders with a number-average molecular weight M̅ₙ from 104 to 500 g/mol and with the general formula (I) or (II)

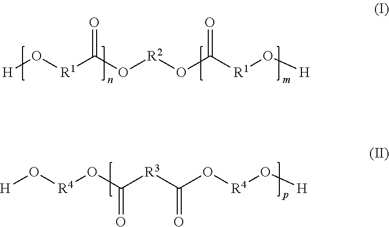

with
R1: branched or unbranched alkylene residues with 1 to 12 C atoms or substituted or non-substituted alkarylene residues with 6 to 24 C atoms,
R2, R4: branched or unbranched alkylene residues or alkoxyalkyl residues with 1 to 12 C atoms or substituted or non-substituted alkarylene residues or substituted or non-substituted alkoxyarylene residues with 6 to 24 C atoms,
R3: branched or unbranched alkylene residues with 1 to 8 C atoms or substituted or non-substituted alkarylene residues with 6 to 20 C atoms, substituted or non-substituted arylene residues with 6 to 20 C atoms, substituted or non-substituted aralkylene residues with 6 to 20 C atoms, n, m=independently of one another are integers from 0 to 10 and
n+m≧1 and p=1 to 10,
or mixtures thereof,

c) a polyol component, substantially consisting of
c1) 50 to 100 mol % of at least one polycarbonate diol with a number-average molecular weight M̅ₙ from 500 to 3000 g/mol and
c2) 0 to 50 mol % of another polymeric diol, different from polycarbonate diols, with a number-average molecular weight M̅ₙ from 450 to 6000 g/mol,
   wherein the ratio of the number of isocyanate groups in component a) to the number of groups that are reactive towards isocyanate in components b), c) and optionally g) amounts to 0.9:1 to 1.1:1, with addition of

e) optionally catalysts,

f) optionally additives and/or auxiliary substances,

g) optionally monofunctional chain terminators, and that additionally contain
d) 0.4 to 10 wt. %, relative to the total weight of the composition, of a mixture consisting of
   d1) 0.1 to 4 wt. %, relative to the total weight of the composition, of at least one amorphous and/or crystalline silicon dioxide,
   and special polyorganosiloxane mixtures of the general formula (R₂SiO)ₙ, wherein R represents an organic hydrocarbon residue which may be either of linear or of branched structure and exhibits 1 to 27 carbon atoms, and n is an integer from 3 to 8000, wherein the polyorganosiloxane mixture consists of
   d2) 0 to 2 wt. %, relative to the total weight of the composition, of one or more polyorganosiloxanes (R₂SiO). with n=3 to 300 and
   d3) 0.2 to 8 wt. %, relative to the total weight of the composition, of one or more polyorganosiloxanes (R₂SiO)_{b} with n=1000 to 8000.

Preferred embodiments are such compositions containing thermoplastic polyurethane that is obtainable from

a) an isocyanate component, substantially consisting of
a1) 65 to 100 mol % 1,6-hexamethylene diisocyanate and
a2) 0 to 35 mol % of an aliphatic diisocyanate that is different from 1,6-hexamethylene diisocyanate, or a mixture of such aliphatic diisocyanates and/or cycloaliphatic diisocyanates.

b) a low-molecular polyol component, substantially consisting of
b1) 35 to 100 mol % of at least one difunctional chain extender with a number-average molecular weight M̅ₙ, from 90 to 286 g/mol and
b2) 0 to 65 mol % of one or more chain extenders with a number-average molecular weight n from 104 to 500 g/mol and with the general formula (I) or (II)

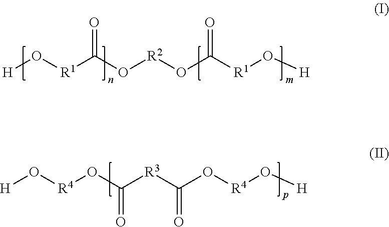

with
R1: branched or unbranched alkylene residues with 1 to 12 C atoms or substituted or non-substituted alkarylene residues with 6 to 24 C atoms,
R2, R4: branched or unbranched alkylene residues or alkoxyalkyl residues with 1 to 12 C atoms or substituted or non-substituted alkarylene residues or substituted or non-substituted alkoxyarylene residues with 6 to 24 C atoms,
R3: branched or unbranched alkylene residues with 1 to 8 C atoms or substituted or non-substituted alkarylene residues with 6 to 20 C atoms, substituted or non-substituted arylene residues with 6 to 20 C atoms, substituted or non-substituted aralkylene residues with 6 to 20 C atoms,
n, m=independently of one another are integers from 0 to 10 and n+m≧1 and p=1 to 10, or mixtures thereof,
c) a polyol component, substantially consisting of
c1) 65 to 100 mol % of at least one polycarbonate diol with a number-average molecular weight M̅ₙ from 500 to 3000 g/mol and
c2) 0 to 35 mol % of a polyether diol and/or polyester diol with a number-average molecular weight M̅ₙ from 450 to 4000 g/mol,
   wherein the ratio of the number of isocyanate groups in component a) to the number of groups that are reactive towards isocyanate in components b), c) and optionally g) amounts to 0.9:1 to 1.1:1,
   with addition of
e) optionally catalysts,
f) optionally additives and/or auxiliary substances,
g) optionally monofunctional chain terminators, and that additionally contain
d) 0.4 to 10 wt. %, relative to the total weight of the composition, of a mixture consisting of
   d1) 0.1 to 4 wt. %, relative to the total weight of the composition, of at least one amorphous and/or crystalline silicon dioxide,
   and special polyorganosiloxane mixtures of the general formula (R₂SiO)ₙ, wherein R represents an organic hydrocarbon residue which may be either of linear or of branched structure and exhibits 1 to 27 carbon atoms, and n is an integer from 3 to 8000, wherein the polyorganosiloxane mixture consists of
   d2) 0 to 2 wt. %, relative to the total weight of the composition, of one or more polyorganosiloxanes (R₂SiO)ₙ with n=3 to 300 and
   d3) 0.2 to 8 wt. %, relative to the total weight of the composition, of one or more polyorganosiloxanes (R₂SiO)ₙ with n=1000 to 8000.

Further preferred embodiments are such compositions containing thermoplastic polyurethane that is obtainable from

a) an isocyanate component, substantially consisting of
a1) 70 to 100 mol % 1,6-hexamethylene diisocyanate and
a2) 0 to 30 mol % of an aliphatic diisocyanate that is different from 1,6-hexamethylene diisocyanate, or a mixture of such aliphatic diisocyanates and/or cycloaliphatic diisocyanates.

b) a low-molecular polyol component, substantially consisting of
b1) 35 to 95 mol % of at least one difunctional chain extender with a number-average molecular weight M̅ₙ from 118 to 286 g/mol and
b2) 5 to 65 mol % of one or more chain extenders with a number-average molecular weight n from 104 to 500 g/mol and with the general formula (I) or (II)

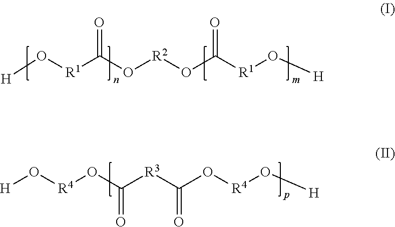

with
R1: branched or unbranched alkylene residues with 1 to 12 C atoms or substituted or non-substituted alkarylene residues with 6 to 24 C atoms,
R2, R4: branched or unbranched alkylene residues or alkoxyalkyl residues with 1 to 12 C atoms or substituted or non-substituted alkarylene residues or substituted or non-substituted alkoxyarylene residues with 6 to 24 C atoms,
R3: branched or unbranched alkylene residues with 1 to 8 C atoms or substituted or non-substituted alkarylene residues with 6 to 20 C atoms, substituted or non-substituted arylene residues with 6 to 20 C atoms, substituted or non-substituted aralkylene residues with 6 to 20 C atoms, n, m=independently of one another are integers from 0 to 10 and n+m≧1 and p=1 to 10,
or mixtures thereof,

c) a polyol component, substantially consisting of
c1) 70 to 100 mol % of at least one polycarbonate diol with a number-average molecular weight M̅ₙ from 500 to 2500 g/mol and
c2) 0 to 30 mol % of a polyether diol and/or polyester diol with a number-average molecular weight M̅ₙ from 450 to 4000 g/mol,
wherein the ratio of the number of isocyanate groups in component a) to the number of groups that are reactive towards isocyanate in components b), c) and optionally g) amounts to 0.9:1 to 1.1:1, with addition of

e) optionally catalysts,

f) optionally additives and/or auxiliary substances,

g) optionally monofunctional chain terminators, and that further contain

d) 0.4 to 10 wt. %, relative to the total weight of the composition, of a mixture consisting of
d1) 0.1 to 4 wt. %, relative to the total weight of the composition, of at least one amorphous and/or crystalline silicon dioxide,
and special polyorganosiloxane mixtures of the general formula (R₂SiO)ₙ, wherein R represents an organic hydrocarbon residue which may be either of linear or of branched structure and exhibits 1 to 27 carbon atoms, and n is an integer from 3 to 8000, wherein the polyorganosiloxane mixture consists of
d2) 0 to 2 wt. %, relative to the total weight of the composition, of one or more polyorganosiloxanes (R₂SiO)ₙ with n=3 to 300 and
d3) 0.2 to 8 wt. %, relative to the total weight of the composition, of one or more polyorganosiloxanes (R₂SiO)ₙ with n=1000 to 8000.

Further preferred embodiments are such compositions containing thermoplastic polyurethane that is obtainable from

a) an isocyanate component, substantially consisting of 1,6-hexamethylene diisocyanate

b) a low-molecular polyol component, substantially consisting of
b1) 40 to 90 mol % of at least one difunctional chain extender with a number-average molecular weight M̅ₙ from 118 to 286 g/mol and
b2) 10 to 60 mol % of one or more chain extenders with a number-average molecular weight n from 104 to 500 g/mol and with the general formula (I) or (II)

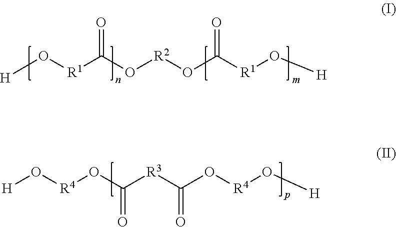

with
R1: branched or unbranched alkylene residues with 1 to 12 C atoms or substituted or non-substituted alkarylene residues with 6 to 24 C atoms,
R2, R4: branched or unbranched alkylene residues or alkoxyalkyl residues with 1 to 12 C atoms or substituted or non-substituted alkarylene residues or substituted or non-substituted alkoxyarylene residues with 6 to 24 C atoms,
R3: branched or unbranched alkylene residues with 1 to 8 C atoms or substituted or non-substituted alkarylene residues with 6 to 20 C atoms, substituted or non-substituted arylene residues with 6 to 20 C atoms, substituted or non-substituted aralkylene residues with 6 to 20 C atoms,
n, m=independently of one another are integers from 0 to 10 and
n+m≧1 and p=1 to 10,
or mixtures thereof,

c) a polyol component, substantially consisting of at least one polycarbonate diol with a number-average molecular weight M̅ₙ from 500 to 2500 g/mol
wherein the ratio of the number of isocyanate groups in component a) to the number of groups that are reactive towards isocyanate in components b), c) and optionally g) amounts to 0.9:1 to 1.1:1, with addition of

e) optionally catalysts,

f) optionally additives and/or auxiliary substances,

g) optionally monofunctional chain terminators, and that contain

d) 0.4 to 10 wt. %, relative to the total weight of the composition, of a mixture consisting of
d1) 0.1 to 4 wt. %, relative to the total weight of the composition, of at least one amorphous and/or crystalline silicon dioxide,
and special polyorganosiloxane mixtures of the general formula (R₂SiO)ₙ,

wherein R represents an organic hydrocarbon residue which may be either of linear or of branched structure and exhibits 1 to 27 carbon atoms, and n is an integer from 3 to 8000, wherein the polyorganosiloxane mixture consists of
d2) 0 to 2 wt. %, relative to the total weight of the composition, of one or more polyorganosiloxanes (R₂SiO)ₙ with n=3 to 300 and
d3) 0.2 to 8 wt. %, relative to the total weight of the composition, of one or more polyorganosiloxanes (R₂SiO)ₙ with n=1000 to 8000.

### DETAILED DESCRIPTION OF EMBODIMENTS

As used herein, the singular terms “a” and “the” are synonymous and used interchangeably with “one or more” and “at least one,” unless the language and/or context cleary indicates otherwise. Accordingly, for example, reference to “a polyol component” herein or in the appended claims can refer to a single polyol or more than one polyol. Additionally, all numerical values, unless otherwise specifically noted, are understood to be modified by the word “about.”

Within the scope of this application, “substantially consisting of signifies “consisting of in a predominant proportion (more than 50%)”, preferably “consisting of” in a proportion amounting to more than 80%”, particularly preferably “consisting of in a proportion amounting to more than 90%”, likewise particularly preferably “consisting of in a proportion amounting to more than 95%”, and quite particularly preferably “consisting of in a proportion amounting to 99-100% or totally consisting of”.

By way of organic diisocyanates (a), use may be made of aliphatic, araliphatic and cycloaliphatic diisocyanates or any mixtures of these diisocyanates (cf. HOUBEN-WEYL Methoden der organischen Chemie, Volume E20, Makromolekulare Stoffe, Georg Thieme Verlag, Stuttgart, New York 1987, pp. 1587-1593 or Justus Liebigs Annalen der Chemie, 562, pages 75 to 136).

In detail, the following may be mentioned in exemplary manner: aliphatic diisocyanates such as ethylene diisocyanate, 1,4-tetramethylene diisocyanate, 1,6-hexamethylene diisocyanate, 1,12-dodecane diisocyanate; cycloaliphatic diisocyanates such as isophorone diisocyanate, 1,4-cyclohexane diisocyanate, 1-methyl-2,4-cyclohexane diisocyanate and 1-methyl-2,6-cyclohexane diisocyanate and also the corresponding isomer mixtures, 4,4′-dicyclohexylmethane diisocyanate, 2,4′-dicyclohexylmethane diisocyanate and 2,2′-dicyclohexylmethane diisocyanate and also the corresponding isomer mixtures; araliphatic diisocyanates such as m- and p-xylylene diisocyanate or m- and p-tetramethylxylylene diisocyanate. Used preferentially are 1,6-hexamethylene diisocyanate, 1,4-cyclohexane diisocyanate, isophorone diisocyanate, dicyclohexylmethane diisocyanate. The stated diisocyanates may find application individually or in the form of mixtures with one another. They may also be used together with up to 15 mol % (calculated with respect to total diisocyanate) of a polyisocyanate, but at most so much polyisocyanate may be added that a product arises that is still thermoplastically processible. Polyisocyanates are products with an isocyanate functionality of ≧2, such as, for example, modifications of the stated diisocyanates, for example dimers, trimers, allophanates, biurets and urethanes.

The chain-extending agents b) possess, on average, preferentially 1.8 to 3.0 Zerewitinoff-active hydrogen atoms and have a molecular weight from 60 to 450. Preferentially understood by this are those having two to three hydroxyl groups, particularly preferably having two hydroxyl groups.

By way of chain extender b), preferably one or more compounds are employed from the group of the aliphatic diols with 2 to 14 carbon atoms, such as, for example, ethanediol, 1,2-propanediol, 1,3-propanediol, 1,4-butanediol, 2,3-butanediol, 1,5-pentanediol, 1,6-hexanediol, 1,10-decanediol, 1,12-dodecanediol, diethylene glycol, dipropylene glycol, 1,4-cyclohexanediol, 1,4-dimethanolcyclohexane and neopentyl glycol. Also suitable, however, are diesters of terephthalic acid with glycols having 2 to 4 carbon atoms, for example terephthalic acid-bis-ethylene glycol or terephthalic acid-bis-1,4-butanediol, hydroxyyalkylene ethers of hydroquinone, for example 1,4-bis(β-hydroxyethyl)hydroquinone, ethoxylated bisphenols, for example 1,4-bis(β-hydroxyethyl)bisphenol A. The stated diols may also be converted with differing molar quantities of ε-caprolactone, accompanied by ring-opening reaction, so that corresponding chain extenders with higher molecular weight arise. Particularly preferably by way of chain extenders use is made of 1,4-butanediol, 1,6-hexanediol, 1,4-dimethanolcyclohexane, 1,4-bis(β-hydroxyethyl)hydroquinone or 1,4-bis(β-hydroxyethyl)bisphenol A and conversion products thereof with ε-caprolactone. Quite particularly preferred is a chain-extender combination consisting of 1,4-bis(β-hydroxyethyl)hydroquinone and a conversion product derived from hexanediol and ε-caprolactone. In addition, relatively small quantities of triols, such as, for example, trimethylolpropane, glycerin or conversion products thereof, with ε-caprolactone and also mixtures of these trifunctional alcohols may also be added.

Particularly preferred chain extenders b) are mixtures containing
b1) at least one difunctional chain extender with a number-average molecular weight M̅ₙ from 118 to 286 g/mol and
b2) one or more chain extenders with a number-average molecular weight M̅ₙ from 104 to 500 g/mol with the general formulae:

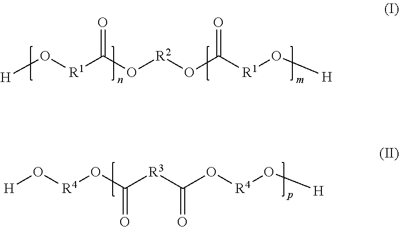

with
R1: branched or unbranched alkylene residues with 1 to 12 C atoms or substituted or non-substituted alkarylene residues with 6 to 24 C atoms,
R2, R4: branched or unbranched alkylene residues or alkoxyalkyl residues with 1 to 12 C atoms or substituted or non-substituted alkarylene residues or substituted or non-substituted alkoxyarylene residues with 6 to 24 C atoms,
R3: branched or unbranched alkylene residues with 1 to 8 C atoms or substituted or non-substituted alkarylene residues with 6 to 20 C atoms, substituted or non-substituted arylene residues with 6 to 20 C atoms, substituted or non-substituted aralkylene residues with 6 to 20 C atoms,
n, m=independently of one another are integers from 0 to 10 and
n+m≧1 and p=1 to 10.

Examples of chain extenders b2) and their production are described, for example, in EP 1 854 818 A1.

By way of polyol component c), those having, on average, at least 1.8 to at most 3.0 Zerewitinoff-active hydrogen atoms and having a number-average molecular weight M̅ₙ from 500 to 10 000 are employed, the molecular weight M̅ₙ being ascertained either by calculation via the OH value, if it is a question of difunctional polymers, or alternatively determined by means of gel-permeation chromatography (GPC). Owing to their production process, the polyols often contain small quantities of non-linear compounds. Frequently one therefore also speaks of “substantially linear polyols”. Preferred are polyester diols, polyether diols, polycarbonate diols or mixtures of these; particularly preferred are polycarbonate diols in a mixture with polyether diols and/or polyester diols; quite particularly preferably, polycarbonate diols or mixtures of various polycarbonate diols are employed as sole polyol component c).

In particular, compounds exhibiting two to three, preferentially two, hydroxyl groups are preferred, especially those having number-average molecular weights M̅ₙ from 450 to 6000, preferably those having number-average molecular weights M̅ₙ from 600 to 4500; particularly preferably those having number-average molecular weights M̅ₙ from 800 to 3000. Polyesters exhibiting hydroxyl groups, polyethers exhibiting hydroxyl groups and polycarbonates exhibiting hydroxyl groups are preferred. Particularly preferred are mixtures consisting of polyethers exhibiting hydroxyl groups and polycarbonates exhibiting hydroxyl groups. Quite particularly preferred by way of polyol component c) are polycarbonates exhibiting hydroxyl groups.

Suitable polycarbonate diols can be produced by chemical reaction of glycols with dimethyl carbonate or diphenyl carbonate, accompanied by elimination of methanol or phenol. Preferred are glycols with 2 to 12, preferentially 2 to 6, carbon atoms, for example ethylene glycol, diethylene glycol, 1,3-propanediol, 1,4-butanediol, 1,5-pentanediol, 1,6-hexanediol, 3-methyl-1,5-pentanediol, 1,4-dimethanolcyclohexane, 1,10-decanediol, 1,12-dodecanediol, 2,2-dimethyl-1,3-propanediol, or dipropylene glycol or conversion products thereof, being converted with ε-caprolactone. Particularly suitable polycarbonate diols have a molecular weight M̅ₙ from 500 to 3000 g/mol and are based on 1,4-butanediol, 1,6-hexanediol, 3-methyl-1,5-pentanediol or mixtures thereof and also conversion products thereof with ε-caprolactone. Quite particularly suitable polycarbonate diols have a molecular weight M̅ₙ from 1000 to 2500 g/mol and are based on 1,4-butanediol, 1,6-hexanediol or mixtures thereof and also conversion products thereof with ε-caprolactone. The proportion of polycarbonate diols in the polyol component c) amounts to at least 50 mol %, preferentially at least 70 mol %, particularly preferably at least 85 mol %, and quite particularly preferably 100 mol %.

Suitable polyether diols can be produced by one or more alkylene oxides with 2 to 4 carbon atoms in the alkylene residue being converted with a starter molecule that contains two active hydrogen atoms in bonded form. By way of alkylene oxides, the following may be mentioned, for example: ethylene oxide, 1,2-propylene oxide, epichlorohydrin and 1,2-butylene oxide and 2,3-butylene oxide. Ethylene oxide, propylene oxide and mixtures consisting of 1,2-propylene oxide and ethylene oxide preferentially find application. The alkylene oxides may be used individually, alternately in succession, or in the form of mixtures. By way of starter molecules there enter into consideration, for example: water, amino alcohols, such as N-alkyldiethanolamine, for example N-methyldiethanolamine, and diols, such as ethylene glycol, 1,3-propylene glycol, 1,4-butanediol and 1,6-hexanediol. Optionally, mixtures of starter molecules may also be employed. Suitable polyether polyols are furthermore the hydroxyl-group-containing polymerisation products of tetrahydrofuran. Trifunctional polyethers in proportions from 0 to 30 wt. %, relative to the bifunctional polyethers, may also be employed, but at most in such a quantity that a product arises that is still thermoplastically processable. The substantially linear polyether diols preferentially possess number-average molecular weights M̅ₙ from 500 to 6000 g/mol. They may find application both individually and in the form of mixtures with one another. Quite particularly suitable polyether diols have a molecular weight M̅ₙ from 1000 to 4000 g/mol. The proportion of polyether diols in the polyol component c) amounts to ≦50 mol %, preferentially ≦30 mol %, particularly preferably ≦15 mol %, and quite particularly preferably 0 mol %.

Suitable polyester diols can, for example, be produced from dicarboxylic acids with 2 to 12 carbon atoms, preferentially 4 to 6 carbon atoms, and polyhydric alcohols. By way of dicarboxylic acids there enter into consideration, for example: aliphatic dicarboxylic acids, such as succinic acid, glutaric acid, adipic acid, suberic acid, azelaic acid and sebacic acid, or aromatic dicarboxylic acids, such as phthalic acid, isophthalic acid and terephthalic acid, or possible cyclic anhydrides thereof. The dicarboxylic acids may be used individually or in the form of mixtures, for example in the form of a mixture of succinic acid, glutaric acid and adipic acid. For the purpose of producing the polyester diols it may, where appropriate, be advantageous to use, instead of the dicarboxylic acids, the corresponding dicarboxylic-acid derivatives, such as carboxylic acid diesters with 1 to 4 carbon atoms in the alcohol residue, carboxylic acid anhydrides or carboxylic acid chlorides. Examples of polyhydric alcohols are glycols with 2 to 10, preferentially 2 to 6, carbon atoms, for example ethylene glycol, diethylene glycol, 1,4-butanediol, 1,5-pentanediol, 1,6-hexanediol, 1,10-decanediol, 1,12-dodecanediol, 2,2-dimethyl-1,3-propanediol, 1,3-propanediol or dipropylene glycol. Depending on the desired properties, the polyhydric alcohols may be used on their own or in a mixture with one another. Suitable furthermore are esters of carbonic acid with the stated diols, in particular those having 4 to 6 carbon atoms, such as 1,4-butanediol or 1,6-hexanediol, or esters of carbonic acid with conversion products of the stated diols and ε-caprolactone, condensation products of w-hydroxycarboxylic acids, such as w-hydroxycaproic acid, or polymerisation products of lactones, for example optionally substituted ε-caprolactones. Used preferentially by way of polyester diols are ethanediol polyadipates, 1,4-butanediol polyadipates, ethanediol-1,4-butanediol polyadipates, 1,6-hexanediol-neopentyl glycol polyadipates, 1,6-hexanediol-1,4-butanediol polyadipates and polycaprolactones. The polyester diols possess number-average molecular weights M̅ₙ from 500 to 10 000 and may find application individually or in the form of mixtures with one another. Quite particularly suitable polyester diols have a molecular weight M̅ₙ from 800 to 4000 g/mol and are based on adipic acid by way of acid component and also 1,4-butanediol, 1,6-hexanediol and 2,2-dimethyl-1,3-propanediol and mixtures thereof by way of alcohol component. The proportion of polyester diols in the polyol component c) amounts to ≦50 mol %, preferentially ≦30 mol %, particularly preferably ≦15 mol %, and quite particularly preferably 0 mol %.

By way of products d1) in d), standard commercial compounds of the general formula SiO₂ may be employed. Meant by this are all forms of silicon dioxide (also designated as silica). Mention may be made, in exemplary manner, of modified and unmodified pyrogenic silicic acids, kieselguhr, diatoms, silica glass, non-crystalline amorphous SiO₂ such as occurs in nature, for example, in geyserite, tachylite or tektite, crystalline SiO₂ such as occurs in nature, for example, in moganite, quartz or tridymite, or amorphous, synthetically produced SiO₂.

By way of polyorganosiloxanes d2) and d3) in d), compounds of the general formula (R₂SiO)ₙ, wherein R represents an organic hydrocarbon residue which may be either of linear or of branched structure and exhibits 1 to 27 carbon atoms, are employed. Of the repeat units, at least 3 and at most 8000 are present. The polyorganosiloxanes d2) and d3) may be added in bulk or by way of master batch in a carrier substance. By way of carrier substance, thermoplastic elastomers enter into consideration, such as, for example, polyether esters, polyester esters, thermoplastic polyurethanes (TPU), styrene-ethylene-butadiene-styrene (SEBS), acrylonitrile-butadiene-styrene (ABS), styrene-acrylonitrile (SAN), polyamide (PA), acrylate-styrene-acrylate block copolymer (ASA), polybutylene terephthalate (PBT), polycarbonate (PC), polyether block amide (PEBA), polymethylmethacrylate (PMMA), polyoxymethylene (POM) or polyvinyl chloride (PVC). Preferred are thermoplastic polyurethanes, particularly preferably aliphatic thermoplastic polyurethanes.

Component d) may be added already in the course of production of the TPU, for example into a housing of a reaction extruder, to the TPU raw materials, for example to the polyol mixture or to an individual polyol with separate metering, to the chain extender or to the chain-extender mixture in the case of more than one chain extender, or after production of the TPU to the finished TPU, for example by means of compounding. Component d) is preferably added by means of compounding.

The relative quantities of the Zerewitinoff-active compounds are preferably so chosen that the ratio of the number of isocyanate groups to the number of groups that are reactive towards isocyanate amounts to 0.9:1 to 1.1:1.

Suitable catalysts e) are the tertiary amines that are known and conventional in accordance with the state of the art, such as, for example, triethylamine, dimethylcyclohexylamine, N-methylmorpholine, N,N′-dimethylpiperazine, 2-(dimethylaminoethoxy)ethanol, diazabicyclo[2,2,2]octane and similar, and also, in particular, organic metal compounds such as titanic acid esters, iron compounds, bismuth compounds or tin compounds such as tin diacetate, tin dioctoate, tin dilaurate or the dialkyltin salts of aliphatic carboxylic acids, such as dibutyltin diacetate or dibutyltin dilaurate or similar. Preferred catalysts are organic metal compounds, in particular titanic acid esters, iron compounds, tin compounds and bismuth compounds. The total quantity of catalysts in the TPU according to the invention amounts, as a rule, preferentially to 0 to 5 wt. %, preferably 0 to 2 wt. %, relative to the total quantity of TPU.

The thermoplastic polyurethanes according to the invention may contain auxiliary substances and additives f). Typical auxiliary substances and additives are lubricants and mould-release agents, such as fatty-acid esters, metallic soaps thereof, fatty-acid amides, fatty-acid ester amides, antiblocking agents, flameproofing agents, plasticisers (as described, for example, by M. Szycher in M. Szycher's Handbook of Polyurethanes, 1999, CRC Press, pages 8-28 to 8-30; the following may be mentioned in exemplary manner: phosphates, carboxylates (such as, for example, phthalates, adipates, sebacates), silicones and alkylsulfonic acid esters), inhibitors, stabilisers against hydrolysis, heat and discoloration, light stabilisers (preferentially UV stabilisers, antioxidants and/or HALS compounds; further details can be gathered from the specialist literature and are described, for example, in Plastics Additives Handbook, 2001 5th. Ed., Carl Hanser Verlag, Munich), dyestuffs, pigments, inorganic and/or organic fillers, fungistatically and bacteriostatically acting substances and mixtures thereof.

Further details concerning the stated auxiliary substances and additives can be gathered from the specialist literature, for example from the monograph by J. H. Saunders and K. C. Frisch entitled “High Polymers”, Volume XVI, Polyurethane, Parts 1 and 2, Interscience Publishers 1962 and 1964, from the Taschenbuch for Kunststoff-Additive by R. Gachter and H. Müller (Hanser Verlag Munich 1990) or from DE-A 29 01 774.

Further additives that can be worked into the TPU are thermoplastics, for example polycarbonate and acrylonitrile/butadiene/styrene terpolymers (ABS), in particular ABS. Use may also be made of other elastomers such as rubber, ethylene/vinyl-acetate copolymers, styrene/butadiene copolymers and also other TPU.

The addition of the auxiliary substances and additives f) may be undertaken during the process for producing the TPU and/or during an additional compounding of the TPU.

Monofunctional compounds reacting towards isocyanates can be employed in proportions up to 2 wt. %, relative to the TPU, as so-called chain terminators g). Suitable are, for example, monoamines, such as butylamine and dibutylamine, octylamine, stearylamine, N-methylstearylamine, pyrrolidine, piperidine or cyclohexylamine, monoalcohols such as butanol, 2-ethylhexanol, octanol, dodecanol, stearyl alcohol, the various amyl alcohols, cyclohexanol and ethylene glycol monomethyl ether.

The compositions according to the invention are preferentially employed in the injection-moulding process, extrusion process and/or powder-slush process.

The compositions according to the invention are preferably employed for producing heat-resistant mouldings and coatings with very good mechanical and chemical surface resistance, in particular high scratch resistance, very high resistance to light and weather, and very good resistance to solvents and chemicals.

The compositions according to the invention are preferably employed for producing heat-resistant, large-area mouldings with very good mechanical and chemical surface resistance, in particular high scratch resistance, very high resistance to light and weather, and very good resistance to solvents and chemicals.

The compositions according to the invention are preferably used for the interior trim of motor vehicles and as external attachments thereof. Particularly preferably, the compositions according to the invention are used as external attachments of motor vehicles.

The invention will be elucidated in greater detail on the basis of the following Examples.

### EXAMPLES

Abbreviations used:
Desmophen® C 2201 polycarbonate diol with a molecular weight of Mₙ=2000 g/mol; product of Bayer MaterialScience AG
Desmophen® C. XP 2613 polycarbonate diol with a molecular weight of Mₙ=2000 g/mol; product of Bayer MaterialScience AG
Acclaim® 2220N polypropylene-oxide/polyethylene-oxide polyol with a molecular weight of 2250 g/mol, product of Bayer MaterialScience AG
Polyester PE225B adipic-acid/butanediol ester with a molecular weight of 2250 g/mol, product of Bayer MaterialScience AG
Terathane® 1000 polytetramethylene glycol with a molecular weight of 1000 g/mol, product of INVISTA (Deutschland) GmbH
Terathane® 2000 polytetramethylene glycol with a molecular weight of 2000 g/mol, product of INVISTA (Deutschland) GmbH
HDI 1,6-hexamethylene diisocyanate (Bayer MaterialScience AG)
HDO 1,6-hexanediol (Lanxess AG)
DDO 1,12-dodecanediol (Beckmann-Kenko GmbH, Bassum, Germany)
HQEE 1,4-bis-(2-hydroxyethoxy)benzene (Saltigo GmbH)
Cap-HDO chain extender based on ε-caprolactone and 1,6-hexanediol according to EP 1 854 818 A1, page 6, line 5, (intermediate product of Bayer MaterialScience AG)
C12 DM mixture of C6-C12 diols (INVISTA Deutschland GmbH) Stabaxol® P200 polycarbodiimide produced by RheinChemie Rheinau GmbH Irganox® 1010 antioxidant produced by Ciba Specialty Chemicals GmbH
Tinuvin® 234 light stabiliser based on a benzotriazole produced by Ciba Specialty Chemicals GmbH
Licowax® E mould-release agent (Clariant GmbH)
K-Kat® 348 bismuth catalyst (King Industries)
DBTL dibutyltin dilaurate
MB40-817® siloxane master batch from Dow Corning, containing high-molecular polyorganosiloxane (n˜3000), silicon dioxide and an aliphatic TPU
MB50-027® siloxane master batch from Dow Corning, containing high-molecular polyorganosiloxane (n˜3000) and an aliphatic TPU
M350® polyorganosiloxane with n˜100-150; silicone oil produced by GE Silicones

Production of an Aliphatic TPU (TPU-1):

A mixture consisting of 984.2 g Desmophen® C 2201, 297.3 g HQEE, 231.8 g Cap-HDO, 6.1 g Irganox® 1010 and 0.98 g DBTL was heated to 110° C. subject to stirring with a paddle agitator at a rotational speed of 500 revolutions per minute (rpm). Then 504.0 g HDI were added in one portion. Subsequently stirring was effected up to the maximally possible rise in viscosity and then the TPU was poured out. The material was thermally aftertreated for 30 min. at 80° C. and subsequently granulated. This material was used as base material for Examples 1 to 3 and 10.

Production of an Aliphatic TPU (TPU-2):

A mixture consisting of 1029.4 g Desmophen® C XP 2613, 202.5 g DDO and 4.5 g Irganox® 1010 was heated to 110° C. subject to stirring with a paddle agitator at a rotational speed of 500 revolutions per minute (rpm). Then 252.0 g HDI were added. Subsequently stirring was effected up to the maximally possible rise in viscosity and then the TPU was poured out. The material was thermally aftertreated for 30 min. at 80° C. and subsequently granulated. This material was used as base material for Examples 4 to 6.

Production of an Aliphatic TPU (TPU-3):

A mixture consisting of 1001.8 g Desmophen® C. 2201, 177.3 g HDO, 4.5 g Irganox® 1010 and 1.0 g K-Kat 348 was heated to 110° C. subject to stirring with a paddle agitator at a rotational speed of 500 revolutions per minute (rpm). Then 333.5 g HDI were added in one portion. Subsequently stirring was effected up to the maximally possible rise in viscosity and then the TPU was poured out. The material was thermally aftertreated for 30 min. at 80° C. and subsequently granulated. This material was used as base material for Examples 7 to 9.

Production of an Aliphatic TPU (TPU-4):

A mixture consisting of 984.2 g Desmophen® C. 2201, 297.3 g HQEE, 179.5 g C12®DM, 5.9 g Irganox® 1010 and 0.98 g DBTL was heated to 110° C. subject to stirring with a paddle agitator at a rotational speed of 500 revolutions per minute (rpm). Then 492.2 g HDI were added in one portion. Subsequently stirring was effected up to the maximally possible rise in viscosity and then the TPU was poured out. The material was thermally aftertreated for 30 min. at 80° C. and subsequently granulated.

Production of an Aliphatic TPU (TPU-5):

A mixture consisting of 1001.8 g Desmophen® C. XP 2613, 297.3 g HQEE, 231.8 g Cap-HDO and 6.1 g Irganox® 1010 was heated to 110° C. subject to stirring with a paddle agitator at a rotational speed of 500 revolutions per minute (rpm). Then 504.0 g HDI were added in one portion. Subsequently stirring was effected up to the maximally possible rise in viscosity and then the TPU was poured out. The material was thermally aftertreated for 30 min. at 80° C. and subsequently granulated.

Production of an Aliphatic TPU (TPU-6):

A mixture consisting of 1001.8 g Desmophen® C. XP 2613, 297.3 g HQEE, 179.5 g C12®DM and 5.9 g Irganox® 1010 was heated to 110° C. subject to stirring with a paddle agitator at a rotational speed of 500 revolutions per minute (rpm). Then 492.2 g HDI were added in one portion. Subsequently stirring was effected up to the maximally possible rise in viscosity and then the TPU was poured out. The material was thermally aftertreated for 30 min. at 80° C. and subsequently granulated.

Production of an Aliphatic TPU (TPU-7):

A mixture consisting of 1001.8 g Desmophen® C XP 2613, 423.6 g C12 DM and 5.7 g Irganox® 1010 was heated to 110° C. subject to stirring with a paddle agitator at a rotational speed of 500 revolutions per minute (rpm). Then 452.8 g HDI were added in one portion. Subsequently stirring was effected up to the maximally possible rise in viscosity and then the TPU was poured out. The material was thermally aftertreated for 30 min. at 80° C. and subsequently granulated.

Production of an Aliphatic TPU (TPU-8):

A mixture consisting of 984.2 g Desmophen® C 2201, 423.6 g C12®DM, 5.6 g Irganox® 1010 and 0.98 g DBTL was heated to 110° C. subject to stirring with a paddle agitator at a rotational speed of 500 revolutions per minute (rpm). Then 452.8 g HDI were added in one portion. Subsequently stirring was effected up to the maximally possible rise in viscosity and then the TPU was poured out. The material was thermally aftertreated for 30 min. at 80° C. and subsequently granulated.

Production of an Aliphatic TPU (TPU-9):

A mixture consisting of 506.5 g Desmophen® C 2201, 242.1 g Acclaim 2220N, 214.7 g HQEE, 167.4 g Cap-HDO, 4.5 g Irganox® 1010 and 0.70 g DBTL was heated to 110° C. subject to stirring with a paddle agitator at a rotational speed of 500 revolutions per minute (rpm). Then 364.0 g HDI were added in one portion. Subsequently stirring was effected up to the maximally possible rise in viscosity and then the TPU was poured out. The material was thermally aftertreated for 30 min. at 80° C. and subsequently granulated.

Production of an Aliphatic TPU (TPU-10):

A mixture consisting of 541.5 g Desmophen® C 2201, 206.7 g PE225B, 214.3 g HQEE, 167.1 g Cap-HDO, 2.1 g Stabaxol® P200, 4.5 g Irganox® 1010 and 0.70 g DBTL was heated to 110° C. subject to stirring with a paddle agitator at a rotational speed of 500 revolutions per minute (rpm). Then 363.2 g HDI were added in one portion. Subsequently stirring was effected up to the maximally possible rise in viscosity and then the TPU was poured out. The material was thermally aftertreated for 30 min. at 80° C. and subsequently granulated.

Production of an Aliphatic TPU (TPU-11):

A mixture consisting of 524.1 g Desmophen® C 2201, 139.2 g Terathane® 1000, 239.3 g HQEE, 186.6 g Cap-HDO, 4.5 g Irganox® 1010 and 0.70 g DBTL was heated to 110° C. subject to stirring with a paddle agitator at a rotational speed of 500 revolutions per minute (rpm). Then 405.6 g HDI were added in one portion. Subsequently stirring was effected up to the maximally possible rise in viscosity and then the TPU was poured out. The material was thermally aftertreated for 30 min. at 80° C. and subsequently granulated.

Production of an Aliphatic TPU (TPU-12):

A mixture consisting of 588.7 g Desmophen® C 2201, 147.2 g Terathane® 2000, 218.4 g HQEE, 170.3 g Cap-HDO, 4.5 g Irganox® 1010 and 0.70 g DBTL was heated to 110° C. subject to stirring with a paddle agitator at a rotational speed of 500 revolutions per minute (rpm). Then 370.2 g HDI were added in one portion. Subsequently stirring was effected up to the maximally possible rise in viscosity and then the TPU was poured out. The material was thermally aftertreated for 30 min. at 80° C. and subsequently granulated.

Master batches or silicone oil (the exact formulations can be gathered from Table 1) and carbon black (2 wt. %, relative to TPU, Elftex® 435 produced by Cabot) were added to the TPU granulated materials produced in accordance with the general descriptions. In an extruder of type DSE 25, 4 Z, 360 Nm with the following structure:
1. cold feed-zone with conveying elements,
2. first heating-zone (165° C.) with first kneading-zone,
3. second heating-zone (175° C.) with conveying elements and second kneading-zone,
4. third heating-zone (180° C.) with third kneading-zone, conveying elements and vacuum degassing,
5. crosshead die (185° C.) and nozzle (180° C.), with a conveying capacity of 10 kg/h at a rotational speed of 220 rpm the mixtures were extruded, subsequently processed into granulated material with a strand granulator and processed into injection-moulded plates with an injection-moulding machine of type Arburg Allrounder 470S within a temperature range from 180 to 230° C. and within a pressure range from 650 to 750 bar at a rate of injection from 10 to 35 cm³/s.

Determination of Technical Processibility:

In the course of injection moulding, special attention was paid to the technical processibility at various temperatures (180 to 230° C.) and pressures (650 to 750 bar). In this connection the feed behaviour, for example, in the funnel of the injection-moulding machine was rated. It was checked whether delamination, defects and/or a bloom on the moulding became visible. Likewise it was assessed how quickly a bloom on the moulding was formed and how thick said bloom was. In this connection the following grading system was introduced for the purpose of assessing the formation of a bloom:

Grade 1: no bloom visible;
Grade 2: little bloom visible and also does not become thicker;
Grade 3: little bloom visible, but after further shots becomes thicker and thicker;
Grade 4: a lot of bloom quickly, which also rapidly becomes thicker with further shots; Only a grading with 1 is very good; a grading with 2 is acceptable.

Determination of Surface Sensitivity

For the determination of surface sensitivity two tests were carried out:

Crockmeter test: These tests were carried out with a crockmeter manufactured by James H. Heal & Co. Ltd., Richmond Works, Halifax, West Yorkshire, HX3 6EP, England, Model 255A, with rubbing finger on an injection-moulded article with a grained surface, to be specific under the following conditions:

rubbing pressure: 10N, rubbing distance: 260 mm, time per rub: 15 sec., number of strokes: 100.

Implementation: The cotton scouring fabric was stretched under the bearing surface, and the test was carried out under the conditions described above. In this connection the damage to the surface was assessed qualitatively.

The grading “poor” signifies a visually distinctly visible abrasion of the surface. The grading “good” signifies no abrasion or barely visible abrasion.

Scratch test: This test was carried out with an Erichsen hardness-testing rod, model 318 with engraving tip Nr. 2 (following the model of ISO 1518, 1.0 mm diameter) with a stroke and with a force of 10 N on a grained surface (line of 10 mm length at a speed of 10 mm/s). In this connection the damage to the surface was assessed qualitatively. The grading “poor” signifies visually distinctly visible damage to the surface. The grading “good” signifies no surface damage or barely visible surface damage.

Determination of the Blooming Behaviour of the Compositions

For the purpose of determining the blooming behaviour three test conditions were chosen, to which the injection-moulded plates produced from the compositions of the Examples were subjected. The plates were subsequently examined qualitatively with regard to bloom formation. The test conditions were the following:

| | |
|---|---|
| Test 1. | Storage at room temperature over a period of 4 weeks |
| Test 2. | Storage at 30° C. in distilled water over a period of 4 weeks |
| Test 3. | Storage at 60° C. in a drying cabinet at a relative atmospheric |
| | moisture of 95% over a period of 4 weeks. |

Determination of the Thermal-Storage Resistance and Hydrolysis Resistance of the Compositions:

Thermal storage: The injection-moulded plates were stored suspended at 120° C. (±2° C. tolerance) for 500 hours.

Hydrolysis storage: The injection-moulded plates were stored suspended at 80° C. (±2° C. tolerance) in de-ionised water for 500 hours.

The results of the investigations can be gathered from the following Table 2.

TABLE 1
Results

| | | Batch; Quantity | | | | | | | Test 3 |
|---|---|---|---|---|---|---|---|---|---|
| | | of MB50-027 ® | | | | | | | (60° C; |
| | | [%] or MB40- | Quantity | Technical | | | | Test 2 | 95% rel. |
| | | 817 ® (contains | M350 ® | Processibility | Crockmeter | Scratch | Test 1 | (30° C. | atm. |
| Example | Type of Example, TPU | silica) [wt. %]** | [%] | (bloom) | test | test | (RT) | H₂O) | moisture) |
| 1 | comparison, TPU-1 | none | none | Grade 3 | Poor | Poor | No bloom | No bloom | No bloom |
| 2* | comparison, TPU-1 | MB50-027; 2.5 | 0.5 | Grade 2 | Good | Good | No bloom | No bloom | Slight |
| | | | | | | | | | bloom |
| 3 | acc. to invention, TPU-1 | MB40-817; 3.6 | 0.5 | Grade 1 | Good | Good | No bloom | No bloom | No bloom |
| 4 | comparison, TPU-2 | None | None | Grade 3 | Poor | Poor | No bloom | No bloom | No bloom |
| 5* | comparison, TPU-2 | MB50-027; 2.5 | None | Grade 3 | Good | Good | No bloom | No bloom | No bloom |
| 6 | acc. to invention, TPU-2 | MB40-817; 4.0 | 0.5 | Grade 1 | Good | Good | No bloom | No bloom | No bloom |
| 7 | comparison, TPU-3 | none | 2.5 | Grade 1 | Good | Poor | No bloom | Slight | Slight |
| | | | | | | | | bloom | bloom |
| 8 | acc. to invention, TPU-3 | MB40-817; 4.0 | 1 | Grade 1 | Good | Good | No bloom | No bloom | No bloom |
| 9 | acc. to invention, TPU-3 | MB40-817; 5.0 | 0.5 | Grade 1 | Good | Good | No bloom | No bloom | No bloom |
| 10 | acc. to invention, TPU-1 | MB40-817; 6.0 | 0.5 | Grade 1 | Good | Good | No bloom | No bloom | No bloom |
| 11 | acc. to invention, TPU-9 | MB40-817, 7.4 | 1 | Grade 1 | Good | Good | No bloom | No bloom | No bloom |
| 12 | comparison, TPU-9 | none | 2.0 | Grade 2 | Poor | Poor | No bloom | Slight | Slight |
| | | | | | | | | bloom | bloom |
| 13* | comparison, TPU 9 | MB50-027, 3.5 | 1.0 | Grade 3 | Good | Good | No bloom | No bloom | Slight |
| | | | | | | | | | bloom |
| 14 | acc. to invention, TPU-10 | MB40-817, 7.4 | 1.0 | Grade 1 | Good | Good | No bloom | No bloom | No bloom |
| 15* | comparison, TPU-10 | MB50-027, 7.4 | 1.0 | Grade 3 | Good | Good | No bloom | No bloom | Slight |
| | | | | | | | | | bloom |
| 16 | acc. to invention. TPU-11 | MB40-817, 7.4 | 1.0 | Grade 1 | Good | Good | No bloom | No bloom | No bloom |
| 17 | comparison, TPU-11 | none | none | Grade 3 | Poor | Poor | No bloom | No bloom | No bloom |
| 18 | acc. to invention, TPU-12 | MB40-817, 7.4 | 1.0 | Grade 1 | Good | Good | No bloom | No bloom | No bloom |
| 19* | comparison, TPU-12 | MB50-027, 6.0 | 1.5 | Grade 2 | Good | Good | No bloom | No bloom | Slight |
| | | | | | | | | | bloom |

*In the course of these injection-moulding experiments distinct surface defects and/or delamination appeared.
**relative to the total weight of the composition

TABLE 2
Results: thermal storage and hydrolysis test

| | After thermal storage | | After hydrolysis storage | |
|---|---|---|---|---|
| | % tear | % elongation | % tear | % elongation |
| | resistance | at break | resistance | at break |
| Comparison* | 84.7 | 85.2 | 87.9 | 86.4 |
| Example 3 | 90.6 | 99.5 | 94.1 | 92.1 |
| Example 11 | 87.5 | 98.9 | 98.8 | 97.0 |
| Example 14 | 95.7 | 100.3 | 96.0 | 90.5 |
| Example 16 | 93.3 | 105.9 | 98.9 | 93.7 |
| Example 18 | 87.5 | 102.8 | 92.6 | 92.8 |

*Example 3 from EP 2 383 305 (European application No. 11163772.4-1214)

The percentage change in tear resistance and elongation at break is calculated as follows: value of tear resistance or elongation at break after hydrolysis storage or thermal storage divided by value of tear resistance or elongation at break before hydrolysis storage or thermal storage multiplied by 100 yields % tear resistance or % elongation at break, respectively.

Discussion of Test Results:

In Examples 1, 4 and 17 no siloxane-containing master batch and no silicone oil was used. The technical processibility and the surface resistance of the plates obtained are poor. In Examples 7 and 12 no siloxane-containing master batch was used, but silicone oil was used. The technical processibility is good, but the scratch test was not passed. With the use of MB50-827® (contains high-molecular polyorganosiloxane) (Examples 2, 5, 13, 15 and 19) the results from the crockmeter test were good and the scratch test was passed, though the technical processibility was not optimal: delamination appeared.

The compositions from Examples 3, 6, 8 to 11, 14, 16 and 18 according to the invention, which contain both a siloxane-containing and silica-containing master batch (MB40-817®) and silicone oil, satisfied all the requirements in terms of surface sensitivity, displayed very good technical processibility with a large processing window, and at all temperature and pressure settings in the course of injection-moulding processing there were no delamination problems. A problem-free continuous processing was possible.

With respect to formation of a bloom, in the course of room-temperature storage the compositions from all the Examples were good. Examples 7 and 12 with relatively high quantity of silicone oil displayed a slight colourless bloom in the case of 30° C. water storage and in the case of 60° C. storage. Examples 2, 13, 15 and 19 displayed a slight colourless bloom in the case of 60° C. storage.

After thermal storage and hydrolysis storage, Examples 3, 11, 14, 16 and 18 according to the invention displayed distinctly better results with respect to tear resistance and elongation at break than the comparative example on the basis of a polyol composition not according to the invention. These results demonstrate the very good hydrolysis-resistance and heat-resistance levels of the TPU products according to the invention.

1. A composition comprising a thermoplastic polyurethane obtained from components comprising:
a) an isocyanate component, substantially consisting of
a1) 50 to 100 mol % 1,6-hexamethylene diisocyanate, and
a2) 0 to 50 mol % of an aliphatic diisocyanate that is different from 1,6-hexamethylene diisocyanate, or a mixture of such aliphatic diisocyanates and/or cycloaliphatic diisocyanates;
b) a low-molecular polyol component, substantially consisting of
b1) 30 to 100 mol % of at least one difunctional chain extender having a number-average molecular weight M̅ₙ from 76 to 286 g/mol and
b2) 0 to 70 mol % of one or more chain extenders having a number-average molecular weight M̅ₙ from 104 to 500 g/mol and having the formulae (I) or (II) 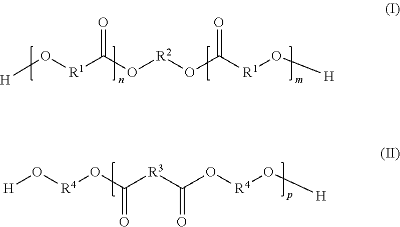
wherein
R1, independently of each other, represents a branched or unbranched alkylene residue having 1 to 12 C atoms or substituted or non-substituted alkarylene residues having 6 to 24 C atoms,
R2, R4, independently of each other, represent a branched or unbranched alkylene residue or alkoxyalkyl residue having 1 to 12 C atoms or substituted or non-substituted alkarylene residue or substituted or non-substituted alkoxyarylene residue having 6 to 24 C atoms,
R3 represents a branched or unbranched alkylene residue having 1 to 8 C atoms or substituted or non-substituted alkarylene residue having 6 to 20 C atoms, substituted or non-substituted arylene residue having 6 to 20 C atoms, substituted or non-substituted aralkylene residue having 6 to 20 C atoms,
n, m represent, independently of one another, an integer from 0 to 10 and
n+m≧1 and p=1 to 10,
or mixtures thereof,
c) a polyol component, substantially consisting of
c1) 50 to 100 mol % of at least one polycarbonate diol having a number-average molecular weight M̅ₙ from 500 to 3000 g/mol and
c2) 0 to 50 mol % of another polymeric diol, different from the at least one polycarbonate diol, having a number-average molecular weight M̅ₙ from 450 to 6000 g/mol,
wherein the ratio of the number of isocyanate groups in component a) to the number of groups that are reactive towards isocyanate in components b), c) and optionally g) amounts to 0.9:1 to 1.1:1,
e) optionally catalysts,
f) optionally additives and/or auxiliary substances,
g) optionally monofunctional chain terminators,
d) 0.4 to 10 wt. %, relative to the total weight of the composition, of a mixture consisting of
d1) 0.1 to 4 wt. %, relative to the total weight of the composition, of at least one amorphous and/or crystalline silicon dioxide,
and a polyorganosiloxane mixture, wherein each of the polyorganosiloxanes is of the formula (R₂SiO)ₙ, wherein R represents an organic hydrocarbon residue which may be either of linear or of branched structure and has 1 to 27 carbon atoms, and n is an integer from 3 to 8000, wherein the polyorganosiloxane mixture consists of
d2) 0 to 2 wt. %, relative to the total weight of the composition, of one or more polyorganosiloxanes (R₂SiO)ₙ with n=3 to 300 and
d3) 0.2 to 8 wt. %, relative to the total weight of the composition, of one or more polyorganosiloxanes (R₂SiO)ₙ with n=1000 to 8000.

2. A composition comprising a thermoplastic polyurethane obtained from components comprising:
a) an isocyanate component, substantially consisting of
a1) 65 to 100 mol % 1,6-hexamethylene diisocyanate and
a2) 0 to 35 mol % of an aliphatic diisocyanate that is different from 1,6-hexamethylene diisocyanate, or a mixture of such aliphatic diisocyanates and/or cycloaliphatic diisocyanates.
b) a low-molecular polyol component, substantially consisting of
b1) 35 to 100 mol % of at least one difunctional chain extender having a number-average molecular weight M̅ₙ, from 90 to 286 g/mol and
b2) 0 to 65 mol % of one or more chain extenders having a number-average molecular weight n from 104 to 500 g/mol and having the formulae (I) or (II) 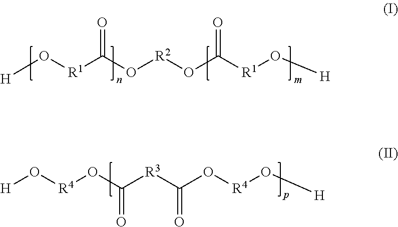
wherien
R1 represents a branched or unbranched alkylene residue having 1 to 12 C atoms or substituted or non-substituted alkarylene residue having 6 to 24 C atoms,
R2, R4: represents, independently of one another, a branched or unbranched alkylene residue or alkoxyalkyl residue having 1 to 12 C atoms or substituted or non-substituted alkarylene residue or substituted or non-substituted alkoxyarylene residue having 6 to 24 C atoms,
R3: represents a branched or unbranched alkylene residue having 1 to 8 C atoms or substituted or non-substituted alkarylene residue haivng 6 to 20 C atoms, substituted or non-substituted arylene residue having 6 to 20 C atoms, substituted or non-substituted aralkylene residue haivng 6 to 20 C atoms,
n, m represent, independently of one another, an integer from 0 to 10 and
n+m≧1 and p=1 to 10
or mixtures thereof,
c) a polyol component, substantially consisting of
c1) 65 to 100 mol % of at least one polycarbonate diol having a number-average molecular weight M̅ₙ from 500 to 3000 g/mol and
c2) 0 to 35 mol % of a polyether diol and/or polyester diol having a number-average molecular weight M̅ₙ from 450 to 4000 g/mol,
wherein the ratio of the number of isocyanate groups in component a) to the number of groups that are reactive towards isocyanate in components b), c) and optionally g) amounts to 0.9:1 to 1.1:1,
e) optionally catalysts,
f) optionally additives and/or auxiliary substances,
g) optionally monofunctional chain terminators,
d) 0.4 to 10 wt. %, relative to the total weight of the composition, of a mixture consisting of
d1) 0.1 to 4 wt. %, relative to the total weight of the composition, of at least one amorphous and/or crystalline silicon dioxide,
and a polyorganosiloxane mixture, wherein each of the polyorganosiloxanes has the formula (R₂SiO)ₙ, wherein R represents an organic hydrocarbon residue which may be either of linear or of branched structure and has 1 to 27 carbon atoms, and n is an integer from 3 to 8000, wherein the polyorganosiloxane mixture consists of
d2) 0 to 2 wt. %, relative to the total weight of the composition, of one or more polyorganosiloxanes (R₂SiO)ₙ with n=3 to 300 and
d3) 0.2 to 8 wt. %, relative to the total weight of the composition, of one or more polyorganosiloxanes (R₂SiO)ₙ with n=1000 to 8000.

3. A composition comprising a thermoplastic polyurethane obtained from components comprising:
a) an isocyanate component, substantially consisting of
a1) 70 to 100 mol % 1,6-hexamethylene diisocyanate and
a2) 0 to 30 mol % of an aliphatic diisocyanate that is different from 1,6-hexamethylene diisocyanate, or a mixture of such aliphatic diisocyanates and/or cycloaliphatic diisocyanates.
b) a low-molecular polyol component, substantially consisting of
b1) 35 to 95 mol % of at least one difunctional chain extender having a number-average molecular weight M̅ₙ from 118 to 286 g/mol and
b2) 5 to 65 mol % of one or more chain extenders having a number-average molecular weight n from 104 to 500 g/mol and having the formulae (I) or (II) 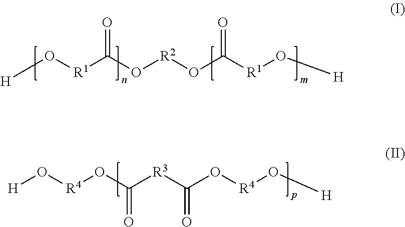
wherein
R1: represents a branched or unbranched alkylene residue having 1 to 12 C atoms or substituted or non-substituted alkarylene residue having 6 to 24 C atoms,
R2, R4: represents, independently of one another, a branched or unbranched alkylene residue or alkoxyalkyl residue having 1 to 12 C atoms or substituted or non-substituted alkarylene residue or substituted or non-substituted alkoxyarylene residue having 6 to 24 C atoms,
R3: represents a branched or unbranched alkylene residue having 1 to 8 C atoms or substituted or non-substituted alkarylene residue having 6 to 20 C atoms, substituted or non-substituted arylene residue having 6 to 20 C atoms, substituted or non-substituted aralkylene residue having 6 to 20 C atoms,
n, m, independently of one another, represent an integer from 0 to 10 and
n+m≧1 and p=1 to 10
or mixtures thereof,
c) a polyol component, substantially consisting of
c1) 70 to 100 mol % of at least one polycarbonate diol having a number-average molecular weight M̅ₙ from 500 to 2500 g/mol and
c2) 0 to 30 mol % of a polyether diol and/or polyester diol having a number-average molecular weight M̅ₙ from 450 to 4000 g/mol,
wherein the ratio of the number of isocyanate groups in component a) to the number of groups that are reactive towards isocyanate in components b), c) and optionally g) amounts to 0.9:1 to 1.1:1,
e) optionally catalysts,
f) optionally additives and/or auxiliary substances,
g) optionally monofunctional chain terminators,
d) 0.4 to 10 wt. %, relative to the total weight of the composition, of a mixture consisting of
d1) 0.1 to 4 wt. %, relative to the total weight of the composition, of at least one amorphous and/or crystalline silicon dioxide,
and a polyorganosiloxane mixture, wherein each of the polyorganosiloxanes have the formula (R₂SiO)ₙ, wherein R represents an organic hydrocarbon residue which may be either of linear and of branched structure and has 1 to 27 carbon atoms, and n is an integer from 3 to 8000, wherein the polyorganosiloxane mixture consists of
d2) 0 to 2 wt. %, relative to the total weight of the composition, of one or more polyorganosiloxanes (R₂SiO)ₙ with n=3 to 300 and
d3) 0.2 to 8 wt. %, relative to the total weight of the composition, of one or more polyorganosiloxanes (R₂SiO)ₙ with n=1000 to 8000.

4. A composition comprising a thermoplastic polyurethane obtained from components comprising:
a) an isocyanate component, substantially consisting of 1,6-hexamethylene diisocyanate
b) a low-molecular polyol component, substantially consisting of
b1) 40 to 90 mol % of at least one difunctional chain extender having a number-average molecular weight M̅ₙ from 118 to 286 g/mol and
b2) 10 to 60 mol % of one or more chain extenders having a number-average molecular weight n from 104 to 500 g/mol and having the formulae (I) or (II) 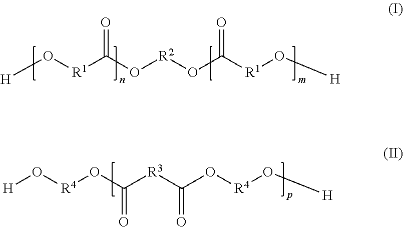
wherein
R1: represents, independently of each other, a branched or unbranched alkylene residue having 1 to 12 C atoms or substituted or non-substituted alkarylene residue having 6 to 24 C atoms,
R2, R4: represent, independently of one another, a branched or unbranched alkylene residue or alkoxyalkyl residue having 1 to 12 C atoms or substituted or non-substituted alkarylene residue or substituted or non-substituted alkoxyarylene residue having 6 to 24 C atoms,
R3: represents a branched or unbranched alkylene residue having 1 to 8 C atoms or substituted or non-substituted alkarylene residue having 6 to 20 C atoms, substituted or non-substituted arylene residue having 6 to 20 C atoms, substituted or non-substituted aralkylene residue haivng 6 to 20 C atoms,
n, m=independently of one another represent an integer from 0 to 10 and
n+m≧1 and p=1 to 10
or mixtures thereof,
c) a polyol component, substantially consisting of at least one polycarbonate diol having a number-average molecular weight M̅ₙ from 500 to 2500 g/mol
wherein the ratio of the number of isocyanate groups in component a) to the number of groups that are reactive towards isocyanate in components b), c) and optionally g) amounts to 0.9:1 to 1.1:1,
e) optionally catalysts,
f) optionally additives and/or auxiliary substances,
g) optionally monofunctional chain terminators,
d) 0.4 to 10 wt. %, relative to the total weight of the composition, of a mixture consisting of
d1) 0.1 to 4 wt. %, relative to the total weight of the composition, of at least one amorphous and/or crystalline silicon dioxide,
and a polyorganosiloxane mixture, wherein each of the polyorganosiloxanes have the formula (R₂SiO)ₙ, wherein R represents an organic hydrocarbon residue which may be either of linear or of branched structure and has 1 to 27 carbon atoms, and n is an integer from 3 to 8000, wherein the polyorganosiloxane mixture consists of
d2) 0 to 2 wt. %, relative to the total weight of the composition, of one or more polyorganosiloxanes (R₂SiO)ₙ with n=3 to 300 and
d3) 0.2 to 8 wt. %, relative to the total weight of the composition, of one or more polyorganosiloxanes (R₂SiO)ₙ with n=1000 to 8000.

5. A method for the production of the composition according to claim 1, wherein component d) is added to the thermoplastic polyurethane during production thereof or is compounded into the finished thermoplastic polyurethane.

6. A method for the production of the composition according to claim 2, comprising adding component d) to the thermoplastic polyurethane during production thereof or compounding component d) into the finished thermoplastic polyurethane.

7. A method for the production of the composition according to claim 3, comprising adding component d) to the thermoplastic polyurethane during production thereof or compounding component d) into the finished thermoplastic polyurethane.

8. A method for the production of the composition according to claim 4, comprising adding component d) to the thermoplastic polyurethane during production thereof or compounding component d) into the finished thermoplastic polyurethane.

9. A moulding or coating comprising the composition according to claim 1.

10. The composition according to claim 1, wherein the composition is subjected to an injection-moulding, extrusion, or powder-slush process.

11. An interior trim in a motor vehicle comprising the composition according to claim 1.

12. An attachment component or bodywork component of a motor vehicle comprising the composition according to claim 1.
